(19) United States
(12) Patent Application Publication
(10) Pub. No.: US 2013/0235403 A1
(43) Pub. Date: Sep. 12, 2013

(54) DEVICE SETTING SYSTEM, DEVICE SETTING METHOD AND IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Syusaku Takara, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/780,176

(22) Filed: Feb. 28, 2013

Related U.S. Application Data
(60) Provisional application No. 61/608,206, filed on Mar. 8, 2012.

(51) Int. Cl. H04N 1/00

(52) U.S. Cl. CPC H04N 1/00084
USPC 358/1.13

(57) ABSTRACT

In accordance with an embodiment, a device setting system comprises a device and an information terminal. The device prints its own current setting value on a sheet in machine-readable form or by using another apparatus. The device acquires a new setting value and reflects the current setting value to be a new setting value. The information terminal reads the printed sheet in machine-readable form, acquires the current setting value of the device from the data read by the reading unit in machine-readable form and changes the setting value to the new setting value and outputs the new setting value changed by the analysis unit in machine-readable form.

### CROSS-REFERENCE TO RELATED APPLICATIONS

This application is based upon and claims the benefit of priority from U.S. Provisional Application No. 61/608,206 filed on Mar. 8, 2012; the entire contents of which are incorporated herein by reference.

### FIELD

Embodiments described herein relate to a device setting technology.

### BACKGROUND

A service is used in recent years to input the error state and the setting information of a device to a mobile terminal to provide an optimal maintenance scheme.

A great amount of time is consumed if data is manually input after reading from a device to be maintained to a mobile terminal in which an analysis program is installed. Thus, in order to achieve a data exchange, it is necessary to read information using a USB (Universal Serial Bus), or to connect the device with the mobile terminal wirelessly or with a cable, or to acquire a barcode using a camera.

Moreover, as there are various limitations in a government organization or enterprise where a high security management is required, it is difficult to exchange information between a device to be maintained and a mobile terminal.

Further, in such an environment, the exchanged information must be kept as history, and sometimes camera is forbidden to be carried or used. Thus, it is difficult to provide a technical service in a location where security and information leakage are strictly limited.

### BRIEF DESCRIPTION OF THE DRAWINGS

FIG. 1 is a schematic diagram illustrating an example of the structure of a device setting system;

FIG. 2 is a block diagram showing an example of the hardware components of a mobile terminal;

FIG. 3 is a schematic diagram illustrating an example of the actions of a device setting system;

FIG. 4 is a diagram illustrating an example of a sheet on which the setting information and the state information of its own apparatus are printed by the image forming apparatus;

FIG. 5 is a flowchart illustrating an example of the actions of a device setting system.

### DETAILED DESCRIPTION

In accordance with an embodiment, a device setting system comprises a device and an information terminal. The device prints its own current setting value on a sheet in machine-readable form or by using another apparatus. The device acquires a new setting value and reflects the current setting value to be a new setting value. The information terminal includes a reading unit configured to read the printed sheet in machine-readable form, an analysis unit configured to acquire the current setting value of the device from the data read by the reading unit in machine-readable form and change the setting value to the new setting value and an output unit configured to output the new setting value changed by the analysis unit in machine-readable form.

In the prior device management and maintenance process, the data (current setting information) output from a device must be sent to a mobile terminal for analysis, the mobile terminal analyzes the data and sends the analyzed data to the device, and the device makes a response. In the embodiment, the actions above are realized in the following way: the current setting information of a device is printed on a sheet, a mobile terminal reads the sheet using a scanner, analyzes the setting information, changes the setting information to new setting information and displays the new setting information on a screen in machine-readable for. The device reads the displayed image using a scanner and acquires the information. In this way, a feedback can be given to the device. In addition, when the device makes a response, the new setting information is printed to reserve the exchange of the data as history.

Moreover, a liquid crystal screen may be used as a scanner on the display of the mobile terminal. The display has a plurality of optical sensor elements in the liquid crystal screen, the surface of which is placed to face the printing side of the sheet so as to acquire an image drawn on the printing sheet.

The device provided in the embodiment has the following functions:

a function of printing state information and setting information in a machine-readable form (e.g. QR code), or a function of printing state information and setting information by using another apparatus;

a scanner function of reading setting information and control information;

a function of reflecting the read setting information thereon and acting in accordance with control information; and

a function of printing the read information.

Further, the mobile terminal provided in the embodiment has the following functions:

a display or scanner function of reading setting information and state information or a function of connecting an external scanner;

a function of analyzing the read data and changing the read data to new setting information and control information; and

a function of displaying the information sent to the device, or a printer function, or a function of connecting an external printer.

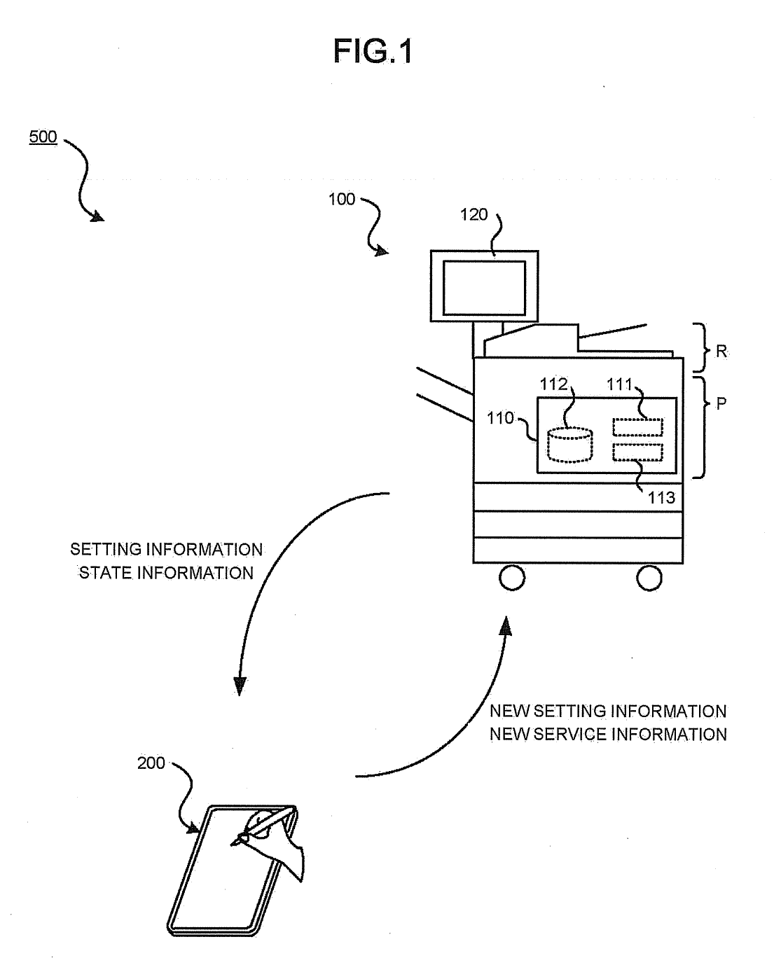

FIG. 1 shows an example of the structure of the system according to the embodiment. A device setting system 500 comprises an image forming apparatus 100 serving as a device to be maintained and a mobile terminal 200 serving as an analysis apparatus used during a maintenance process.

The image forming apparatus 100 comprises a scanner unit R, a printer unit P and a controller 110. The scanner unit R is a unit which reads an original sheet arranged on a transparent plate to generate image data and comprises light-emitting elements and a photographing element such as a CCD Image Sensor (Charge Coupled Device Image Sensor). The printer unit P is a unit which forms the image of the image data read by the scanner unit R or the printing data sent from an external apparatus (e.g. computer) on a sheet. The printer unit P comprises: a toner cartridge for accommodating a toner, an image forming unit for forming an image on the sheet by transferring the toner fed from the toner cartridge to the sheet; and a fixing apparatus for thermally fixing the transferred toner image on the sheet.

The controller 110 is a unit for comprehensively controlling the hardware of the image forming apparatus 100. The controller 110 comprises a processor 111, a storage unit 112 and a communication interface unit 113. The processor 111 is an operation processing apparatus such as a CPU (Central Processing Unit) or an MPU (Micro Processing Unit). The storage unit 112, which consists of a primary memory apparatus such as an RAM (Random Access Memory) and an auxiliary memory apparatus such as a flash memory or a hard disk drive, is configured to store programs and data. The communication interface unit 113, which is a unit sending or receiving external data, comprises a network interface or an interface connected with a public line network. The control carried out by the controller 110 may be partially or completely carried out by an integrated circuit such as an ASIC (Application Specific Integrated Circuit).

The mobile terminal 200 is a computer having a touch panel display on the front surface thereof. The mobile terminal 200 acquires the current setting information and the state information of the image forming apparatus 100 and analyzes the setting information and the state information by changing the setting information and the state information to better setting values. The mobile terminal 200 sends the newly generated/changed setting information to the image forming apparatus 100. Further, the mobile terminal 200 also generates information enabling the currently disabled option service and sends the generated information to the image forming apparatus 100.

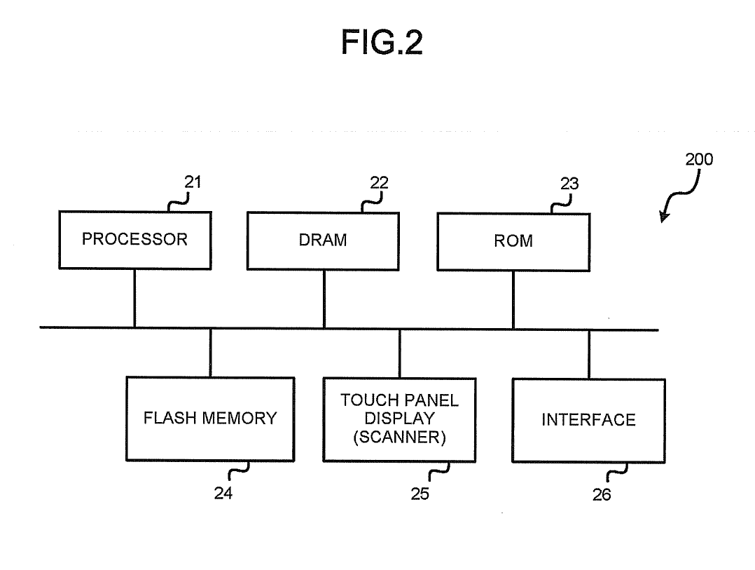

FIG. 2 is a block diagram showing an example of the hardware components of the mobile terminal 200. The mobile terminal 200 comprises a processor 21, a DRAM (Dynamic Random Access Memory) 22, an ROM (Read Only Memory) 23 and a flash memory 24. The program stored in the ROM 23 or the flash memory 24 is loaded into the DRAM 22 and executed by the processor 21 to realize various functions. In addition, an analysis program used by the image forming apparatus 100 is imported into the flash memory 24 in advance.

The mobile terminal 200 comprises a touch panel display 25, which is provided with a display unit serving as a flat panel liquid crystal display and a touch panel type input unit for detecting the contact of the fingertip of the user or a special pen. Moreover, the liquid crystal display of the display unit may also function as a scanner by containing optical sensor elements in liquid crystal pixels.

The mobile terminal 200 has an interface 26 serving as a terminal in accordance with, for example, a USB standard. The interface 26 is connected with, for example, a printer or a scanner. Additionally, the communication interface 26 may be saved in the embodiment.

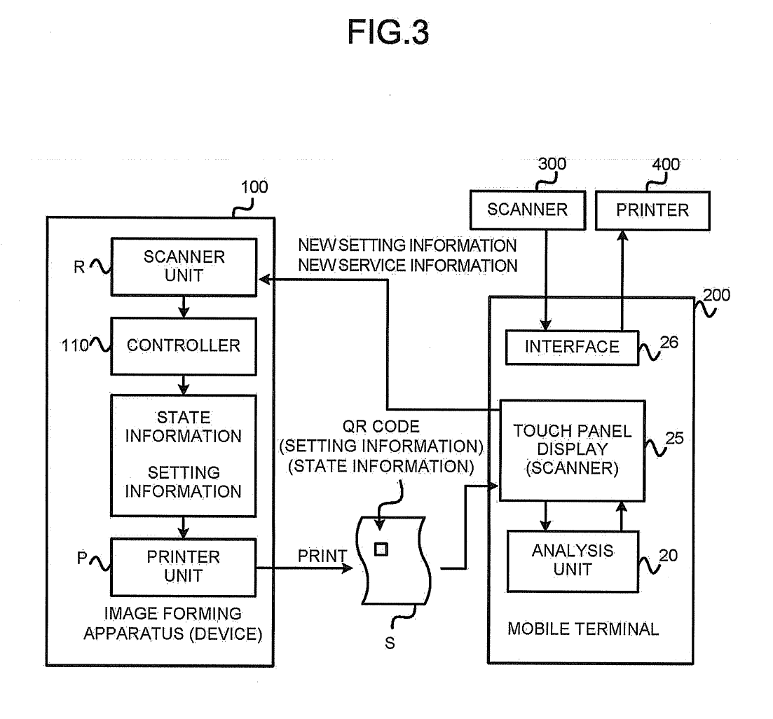

The form of the embodiment is described below with reference to FIG. 3.

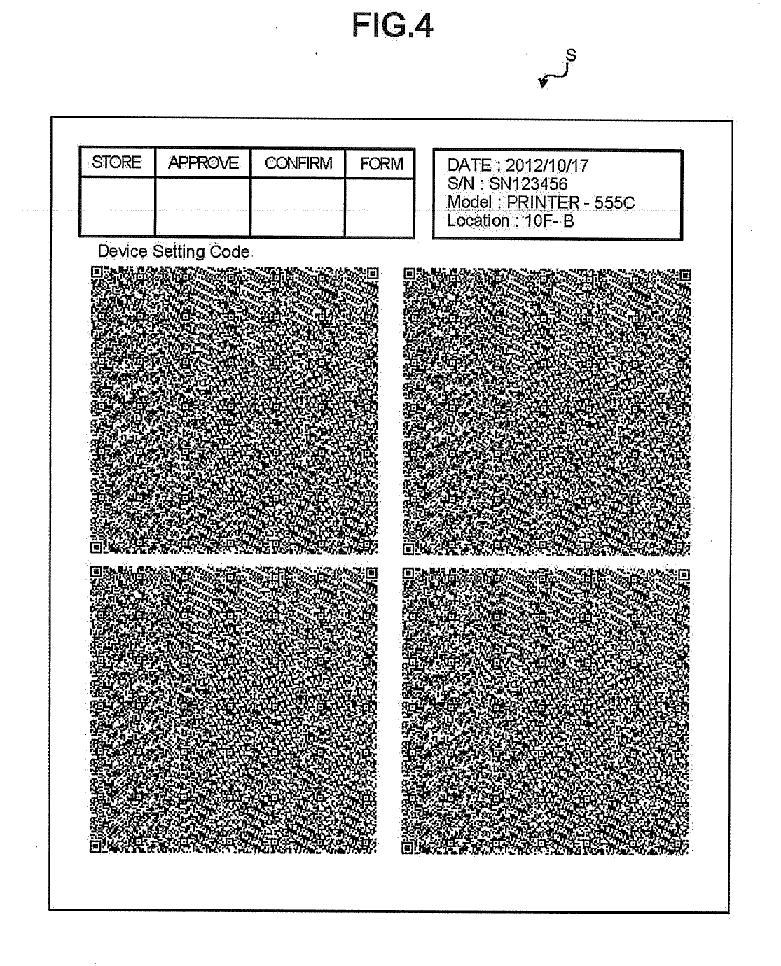

A maintenance person carries the mobile terminal 200 to the location where a device (image forming apparatus 100) is installed to print setting information and state information. FIG. 4 shows an example of a sheet which is being printed at this time. Columns for the sheet keeper, the approver, the maintenance operation confirmer and the worker (maintainer) to affix a seal are arranged on the upper part of a setting information sheet S. Further, an implementation date, the sequence number (S/N) and the model of the image forming apparatus 100 and a setting location are printed on the upper part of the setting information sheet S. Moreover, the setting information is converted to QR codes and then printed.

The format shown in FIG. 4 is only exemplary, and it should be appreciated that the format may be any other format. The reason for the implementation of a printing operation is to cope with a case where the data exchanged by the user must be reserved and checked as history. Thus, preferably, the print format is a general format. For example, the QR code shown in FIG. 4 meets such a requirement. In order to print a great amount of data, a plurality of QR codes are printed on one sheet, or a plurality of QR codes are magnified or reduced to be printed in a printing area which is determined by the readable range and the reading performance of the mobile terminal 200.

In the embodiment, a multifunctional panel such as the touch panel display 25, a built-in scanner (not shown) and an external portable scanner 300 connected with the interface 26 may be used as a member for reading the printed QR codes into the mobile terminal 200. As stated above, by installing a sensor on the display screen of the multifunctional panel, the liquid crystal panel is endowed with a scanner function. By contacting the print on the liquid crystal panel, the mobile terminal 200 having the function above reads information to form image data of the print and analyzes the QR codes to acquire setting values. The acquisition of values from the QR codes can be carried out using the conventional technology.

The mobile terminal 200 analyzes the data read using the touch panel display 25 or the scanner 300 into original data. The analysis unit 20, a functional unit which carries out the analysis above, consists of the processor 21, the DRAM 22 and the flash memory 24. The analysis unit 20 is realized by the processor 21 by executing an analysis program which is imported into the flash memory 24 in advance. The analysis unit 20 analysis an information that what is the best setting information for the device, generates a life information of each parts based on usage condition or an information about new service. This analysis process can use the conventional technology.

An example of a modification and variation on the analysis unit 20 is described below.

The analysis unit 20 acquires the identification information, the timing value and the QR code of a detection sensor to correct detection timing only when a specific position of the sheet conveying path is jammed. In addition, the jam detection times of each detection sensor is printed in a QR form as state information and then read.

If there is a sensor detecting incorrectly, the analysis unit 20 acquires based on a QR code, the identification information of the sensor and a value representing valid/invalid, and changes the value to invalidate the detection.

In a case where jam occurs frequently during a double-sided printing process, the analysis unit 20 acquires the identification information and the bias value of a secondary transfer belt based on a QR code to correct the bias value. The time at which a double-sided printing is carried out can be acquired according to the history information and the setting information (single-sided printing or double-sided printing) of a job, and the information is printed in a QR code form as state information and then read.

When a new service is activated due to the establishment of a license agreement or the import of an option module, the analysis unit 20 generates the identification information of the service and a value representing the validation of the service as service information.

The analysis result (new setting information/service information) of the mobile terminal 200 is feed back to the image forming apparatus 100 to be maintained. In the example, the new setting information and the new service information are displayed on the touch panel display 25 in a QR code form (not limited to this). The image forming apparatus 100 reads the QR code displayed on the touch panel display 25 of the mobile terminal 200 using the scanner unit R. At this time, the original-holding transparent panel of the scanner unit R is contacted with the touch panel display 25 in a face-to-face manner to carry out the reading. Further, the new setting information and the new service information can be printed on a sheet using a built-in printer (not shown) or an external printer 400 connected with the interface 26 or, the sheet is read using the scanner unit R.

The data-reading controller 110 of the image forming apparatus 100 reflects the setting information to the image forming apparatus 100 and prints the image data read by the scanner unit R on the sheet. The maintainer and the confirmer can confirm the data reflected and reserve history on the sheet through the printing.

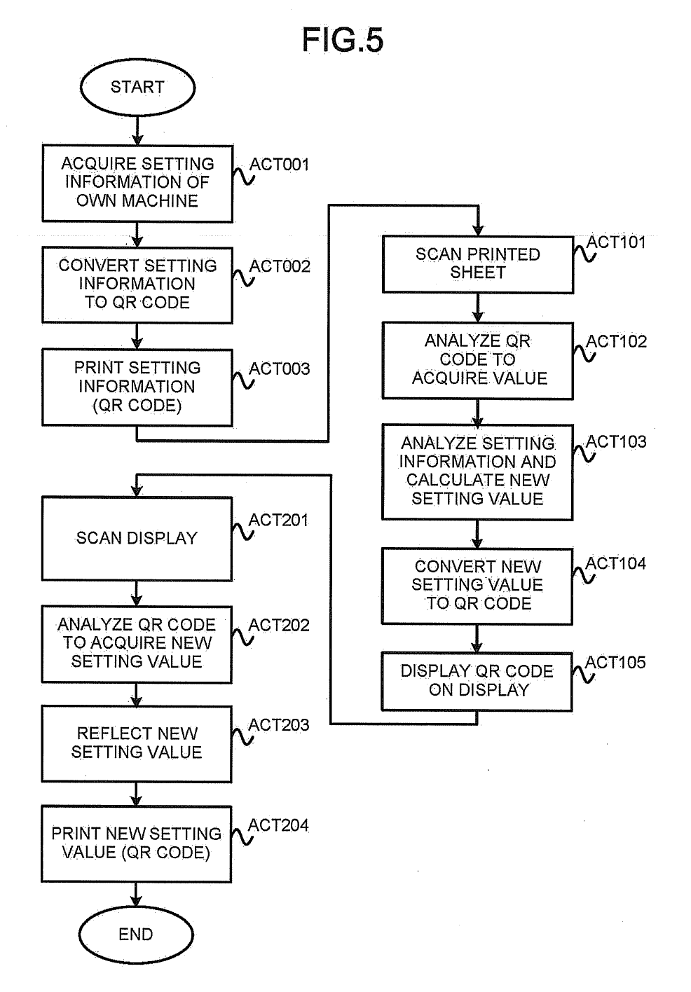

FIG. 5 is a flowchart illustrating an example of the actions of the device setting system 500. ACT001-ACT003 and ACT201-ACT204 are actions of the image forming apparatus 100 to be maintained, and ACT101-ACT105 are actions of the device terminal 200.

First, the controller 110 of the image forming apparatus 100 acquires the setting information and the state information of the image forming apparatus 100 from the storage unit 112 (ACT 001) and converts the information acquired to QR codes (ACT 002). Then, the printer unit P prints the QR codes (ACT 003).

The user contacts a sheet (refer to FIG. 4) printed with the QR codes with the touch panel display 25 of the mobile terminal 200. In addition, the liquid crystal member (light-emitting member) of the touch panel display 25 adjusts the quantity of light, and in the case where the quantity of light cannot be guaranteed, the user reserves a gap between the sheet and the touch panel display 25 so that the sheet and the touch panel display 25 are located in a face-to-face manner to guarantee the quantity of light.

The touch panel display 25 scans a single side of the sheet on which the QR codes are formed (ACT101). The scanned image data is temporarily stored in the DRAM 22 or the flash memory 24. Additionally, ACT101 may also be executed in the following way: the image data of the QR codes may be acquired by using a scanner 300 connected with the interface 26.

The analysis unit 20 analyzes the image data of the QR codes to acquire each setting information value and each state information value (ACT 102). The analysis unit 20 calculates new setting values based on the state information values, the setting information values and, if necessary, the value input by the maintainer (ACT 103).

The analysis unit 20 converts the new setting values to QR codes form to generate image data of the QR codes (ACT 104). At this time, if there is a new service, information of the new service is also generated and converted to a QR code form. Image data of the QR codes is temporarily stored in the DRAM 22 or the flash memory 24.

The image data of the QR codes stored in the DRAM22 or the flash memory 24 in ACT 104 is displayed on the touch panel display 25 (ACT 105).

The user makes the display surface of the touch panel display 25 on which the QR codes are displayed face and contact the original-holding transparent plate of the image forming apparatus 100. The scanner unit R scans and reads the QR codes displayed on the touch panel display 25 (ACT 201). The scanned image is temporarily stored in the storage unit 112.

The controller 110 of the image forming apparatus 100 analyzes the QR codes, acquires the setting values (ACT 202) and reflects new setting values (ACT 203). The reflection is carried out in accordance with control information, like in the prior art. At this time, the image forming apparatus 100 is initialized, if needed. The printer unit P prints the scanned image (the QR code image of new setting value) stored in the storage unit 112 (ACT 204).

After the series of actions above are completed, the information temporarily stored in the image forming apparatus 100 and the mobile terminal 200 is all deleted.

In addition, in ACT 201, the display surface of the touch panel display 25 is scanned by the scanner unit R of the image forming apparatus 100, or the images of the QR codes are formed on the sheet using the printer 400 connected with the interface 26, and the sheet is scanned using the scanner unit R. In this case, there is no need to carry out ACT 204 as the new setting information and the service information are formed on the sheet.

Through the actions above, the customer, that is, the confirmer, can confirm, by viewing the sheet, that only the setting information and the state information of the device are exchanged. In this way, the customer can confirm whether or not confidential information is output outside the device and confirm the data written into a main body. By means of the structure above, data can be exchanged without using a USB memory or a cable.

In the embodiment, the data exchanged between the image forming apparatus 100 and the mobile terminal 200 is in a QR code form, however, the data may be in any other form that is determinable and readable to a machine, such as a barcode form. Moreover, the information reserved as history may be strings as long as the user can appreciate the strings. In a case where strings are used, functions of the conventional OCR (Optical Character Reader) should be compiled into the image forming apparatus 100 and the mobile terminal 200. The strings are also determinable and readable to a machine.

In the embodiment, the image forming apparatus is described as an example of a device to be maintained, however, the device to be maintained is not limited to this. Any device is applicable that can print the information (e.g. QR code) related to the current setting value of the device on a sheet of the device or form the same information on a sheet using another image forming apparatus. Further, any device is applicable that can acquire the information related to a new setting value (e.g. QR code) and reflect the acquired information as the setting value of the device.

In the embodiment, the functions of the apparatus are prerecorded in the apparatus, however, the present invention is not limited to this, the same functions may also be downloaded to the apparatus from a network or stored in a recording medium and then installed in the apparatus. The recording medium may be any recording medium (e.g. CD-ROM) that is capable of storing programs and readable to the apparatus. Further, the function achieved in the manner above can also be achieved by the cooperation with an OS (Operating System) in the device.

The reading unit and the output unit correspond to the touch panel display 25 in the embodiment. Moreover, the reading unit may be a scanner 300. The output unit may be a printer 400.

As stated in detail above, by printing, on a sheet, the information output from a device to the outside, the technology provided herein reserves history to carry out a device setting in an environment having a strict requirement on security.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A device setting system, comprising:
a device configured to print its own current setting value on a sheet in machine-readable form or by using another apparatus, acquire a new setting value and reflect the current setting value to be a new setting value; and
an information terminal includes:
a reading unit configured to read the printed sheet in machine-readable form;
an analysis unit configured to acquire the current setting value of the device from the data read by the reading unit in machine-readable form and change the setting value to the new setting value; and
an output unit configured to output the new setting value changed by the analysis unit in machine-readable form.

2. The device setting system according to claim 1, wherein
the device prints the new setting value on the sheet in machine-readable form or by using another apparatus.

3. The device setting system according to claim 1, wherein
the output unit is an image display which displays the new setting value in machine-readable form; and
the device reads the displayed image by using a scanner unit.

4. The device setting system according to claim 1, wherein
the output unit is a liquid crystal display having a plurality of optical sensor elements therein; and
the reading unit refers to the plurality of optical sensor elements and reads the sheet facing the liquid crystal display.

5. A device setting method, comprising:
printing its own current setting value on a sheet in machine-readable form or by using another apparatus through a device to be maintained;
reading the printed sheet in machine-readable form, acquiring the current setting value of the device from the read data in machine-readable form, changing the setting value to a new setting value and outputting the new setting value in machine-readable form through a computer; and
acquiring the new setting value and reflecting the current setting value to be the new setting value through the device.

6. The device setting method according to claim 5, wherein
the device prints the new setting value on the sheet in machine-readable form or by using another apparatus.

7. The device setting method according to claim 5, wherein
the output of the computer means to display the new setting value in machine-readable form on a display unit; and
the device reads the displayed image by using a scanner unit.

8. The device setting method according to claim 5, wherein
the computer includes a liquid crystal display having a plurality of optical sensor elements therein and reads the sheet facing the liquid crystal display.

9. An image forming apparatus, comprising:
a printer unit configured to print its own current setting value on a sheet in machine-readable form;
a scanner unit configured to read the printed sheet in machine-readable form based on a new setting value; and
a controller configured to reflect the current setting value to be a new setting value

10. The image forming apparatus according to claim 9, wherein
the printer unit prints the new setting value on the sheet in machine-readable form.
